(19) United States
(12) Patent Application Publication
(10) Pub. No.: US 2018/0212789 A1
(43) Pub. Date: Jul. 26, 2018

(54) Communication Method and Storage Medium Storing Communication Program

(71) Applicant: Brother Kogyo Kabushiki Kaisha, Nagoya-shi (JP)

(72) Inventor: Yasuhiro Kudo, Ichinomiya-shi (JP)

(21) Appl. No.: 15/806,891

(22) Filed: Nov. 8, 2017

(30) Foreign Application Priority Data
Jan. 23, 2017 (JP) 2017-009292

(51) Int. Cl. H04L 12/18; H04L 29/06

(52) U.S. Cl. CPC H04L 12/1822; H04L 65/403

(57) ABSTRACT

A communication method includes: connecting the server with a client; receiving a participation request from the client, the participation request including a conference ID; executing a conference process; determining a port number corresponding to the conference ID; transmitting the port number from the server to the conference process; in response to reception of the port number, activating the conference process as a conference server; connecting the server with the conference process; transmitting the participation request from the server to the conference process; in response to reception of the participation request and to transmission of a participation permission to the server, receiving the participation permission; transmitting the participation permission from the server to the client, the participation permission including the port number; in response to reception of the participation permission, connecting the client with the conference process; and performing communication for performing the teleconference between the client and the conference process.

### CROSS REFERENCE TO RELATED APPLICATIONS

This application claims priority from Japanese Patent Application No. 2017-009292 filed Jan. 23, 2017. The entire content of the priority application is incorporated herein by reference.

### TECHNICAL FIELD

This disclosure relates to a communication method for realizing a teleconference by performing communication through a network, and relates to a storage medium storing a communication program.

### BACKGROUND

There is a proposed art that one multi-point control unit (MCU) hosts a plurality of teleconferences at the same time in a system for holding teleconferences between a plurality of communication terminals connected to a network. In the MCU, when a failure occurs in a program managing a plurality of teleconferences, such failure may affect all of the plurality of teleconferences, which is not preferable. The known electronic conference system has a plurality of host apparatuses, a plurality of communication terminals, and a mediation server. The mediation server logically connects two different host apparatuses to each other through a virtual server. This enables the electronic conference system that consists of the plurality of communication terminals respectively connected to each host apparatus to be mediated by the virtual server.

### SUMMARY

According to a first aspect, this specification discloses a communication method for performing a teleconference between clients through a server. The communication method includes: connecting the server with a client; receiving, by the server, a participation request transmitted from the client, the participation request including a conference ID of the teleconference; executing, by the server, a conference process for performing the teleconference; determining, by the server, a port number corresponding to the conference ID; transmitting the port number from the server to the conference process; in response to reception of the port number by the conference process, activating, by the server, the conference process as a conference server that performs the teleconference by using the port number; connecting the server with the conference process by using the port number; transmitting the participation request from the server to the conference process; in response to reception of the participation request by the conference process and to transmission of a participation permission to the server by the conference process, receiving the participation permission by the server; transmitting the participation permission from the server to the client, the participation permission including the port number; in response to reception of the participation permission by the client, connecting the client with the conference process by using the port number included in the participation permission; and performing communication for performing the teleconference corresponding to the conference ID between the client and the conference process.

According to a second aspect, this specification also discloses a non-transitory computer-readable storage medium storing a communication program. The communication program is executable on a computer of a server. The communication program causes, when executed, the server to perform operations including: connecting with a client; receiving a participation request transmitted from the client, the participation request including a conference ID of a teleconference; executing a conference process for performing the teleconference; determining a port number corresponding to the conference ID; transmitting the port number to the conference process; activating the conference process as a conference server that performs the teleconference by using the port number; connecting with the conference process by using the port number; transmitting the participation request to the conference process; receiving a participation permission transmitted from the conference process in response to transmission of the participation request; and transmitting the participation permission to the client, the participation permission including the port number.

According to a third aspect, this specification also discloses a non-transitory computer-readable storage medium storing a communication program. The communication program is executable on a computer of a server. The communication program causes, when executed, the server to perform operations including: executing a conference process for performing a teleconference; determining a port number in response to a port request transmitted from the executed conference process; transmitting the port number to the conference process; activating the conference process as a conference server that performs the teleconference by using the port number; connecting with a client; receiving a participation request transmitted from the client, the participation request including a conference ID of the teleconference; selecting an unused conference process from the activated conference process; connecting with the selected conference process by using the port number; transmitting the participation request to the conference process; receiving a participation permission transmitted from the conference process in response to transmission of the participation request; and transmitting the participation permission to the client, the participation permission including the port number.

### BRIEF DESCRIPTION OF THE DRAWINGS

Embodiments in accordance with this disclosure will be described in detail with reference to the following figures wherein:

FIG. 1 is a diagram showing a communication system 1;

FIG. 2 is a diagram showing a first communication sequence;

FIG. 3 is a flowchart of a client processing;

FIG. 4 is a flowchart of a first server processing;

FIG. 5 is a flowchart of the first server processing, following FIG. 4;

FIG. 6 is a flowchart of a first conference processing;

FIG. 7 is a flowchart of a second communication sequence;

FIG. 8 is a flowchart of a second server processing;

FIG. 9 is a flowchart of an activation processing;

FIG. 10 is a flowchart of a second conference processing; and

FIG. 11 is a flowchart of the second conference processing, following FIG. 10.

### DETAILED DESCRIPTION

For example, the known electronic conference system has a plurality of host apparatuses, a plurality of communication terminals, and a mediation server. In the known electronic conference system, a case of a plurality of virtual servers respectively hosts different teleconferences will be described. In this case, even if a failure occurs in one virtual server, this failure may not affect the teleconferences hosted by other virtual servers unless failures occur in the other virtual servers. However, the known electronic conference system requires a mediation server separately from the MCU. Therefore, there is a case that a system for stably hosting a plurality of teleconferences is not easily configured.

An aspect of this disclosure is to provide a communication method that enables to simply realize a system in which each of a plurality of teleconferences is stably held.

<Overview of Communication System 1>

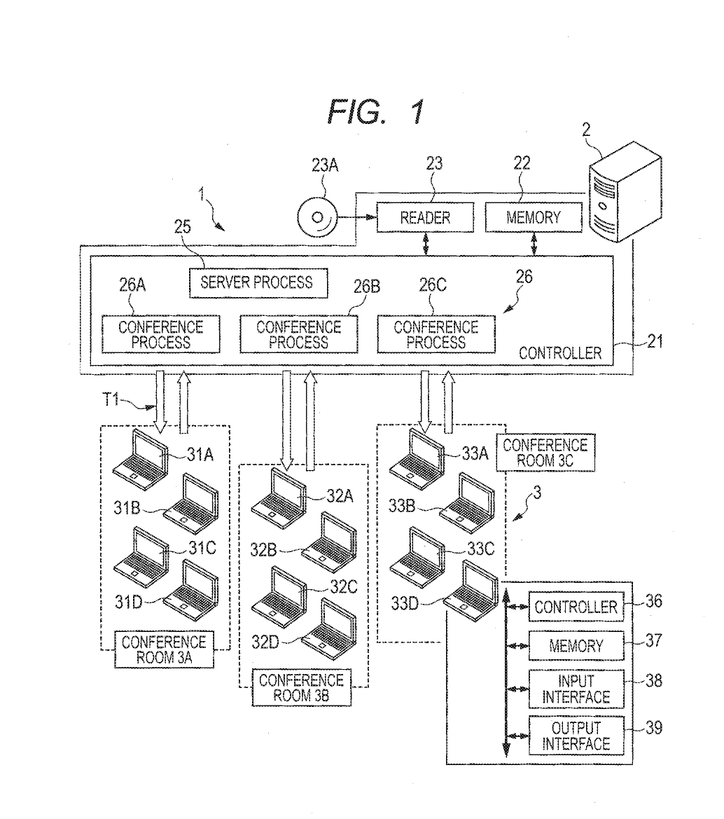

A communication system 1 will be described with reference to FIG. 1. The communication system 1 includes a server 2 and a plurality of clients 3. The server 2 and the plurality of clients 3 are connected to each other through a network (not shown) such as LAN and internet.

Each client 3 performs communication with the server 2, thereby participating in a virtual conference room (hereinafter, simply referred to as “conference room”) to hold a teleconference. Each client 3 is provided by installing an application program for a teleconference on a well-known personal computer (PC). Each client 3 has a controller 36, a memory 37, an input interface 38, and an output interface 39. The controller 36 performs overall control by the client 3. The memory 37 stores various programs executed by the controller 36. The input interface 38 includes a camera, a microphone, a keyboard, a mouse, and so on. The output interface 39 includes a LCD, a speaker, and so on.

The server 2 holds conference rooms for teleconferences among the plurality of clients 3. The server 2 is provided by installing a dedicated application program in a multi-point control unit (MCU) or a known server. The server 2 has a controller 21, a memory 22, and a reader 23. The controller 21 performs overall control by the server 2. The memory 22 stores various programs executed by the controller 21. The reader 23 reads out information stored in a storage medium 23A such as a semiconductor memory and an optical disk. The controller 21 controls the reader 23 to read out the program stored in the storage medium 23A, and stores the program in the memory 22. For example, the program may be downloaded from another server connected to a network (not shown) and be stored in the memory 22.

<Executable File Executed by Server 2>

The controller 21 of the server 2 executes at least the following processes (1) and (2) in order to enable a teleconference among the plurality of clients 3. The process refers to an execution unit of a program installed in the server 2. Each process is started by execution of an executable file stored in the memory 22.

(1) Server Process 25

A server process 25 is always executed by the controller 21. The server process 25 realizes a function of forwarding media data (hereinafter, referred to as “conference data”) transmitted and received when the plurality of clients 3 performs the teleconference. The server process 25 executes a conference process 26 described later, as needed. The server process 25 performs communication with the plurality of clients 3 and the conference process 26.

(2) Conference Process 26

The conference process 26 is executed by the server process 25. The conference process 26 performs communication with the plurality of clients 3 and the server process 25. The conference process 26 realizes functions of a conference server in the teleconference. One of the functions of the conference server is a function of holding a conference room. In order to realize this function, the conference process 26 manages identification information (referred to as “session ID”) indicating a session with each of the clients 3 who participate in the conference room, and identification information (referred to as “conference ID”) indicating the conference room. When the server 2 holds a plurality of conference rooms, the conference processes 26 corresponding to the respective conference rooms are executed by the server process 25.

For example, as shown in FIG. 1, when making clients 31A, 31B, 31C, and 31D participate in a conference room 3A, the conference process 26A associates session IDs (collectively referred to as “T1”) of sessions connected among the clients 31A to 31D with the conference ID “3A” of the conference room, and stores the associated IDs in the memory 22. Thereby, the conference process 26A performs communication of the conference data corresponding to the conference room through the sessions with the clients 31A to 31D. This is similar for the conference processes 26B and 26C. That is, the server 2 performs the conference room 3A performed among the clients 31A to 31D, a conference room 3B performed among the clients 32A to 32D, and the conference room 3C performed among the clients 33A to 33D by separate conference processes 26A, 26B, and 26C, respectively.

Communication among processes of the server 2 described below corresponds to data exchanging among the processes and is different from actual communication through a network. Hereinafter, exchanging data among the processes of the server 2 is referred to as “transmitting and receiving data.”

<Overview of First Communication Sequence>

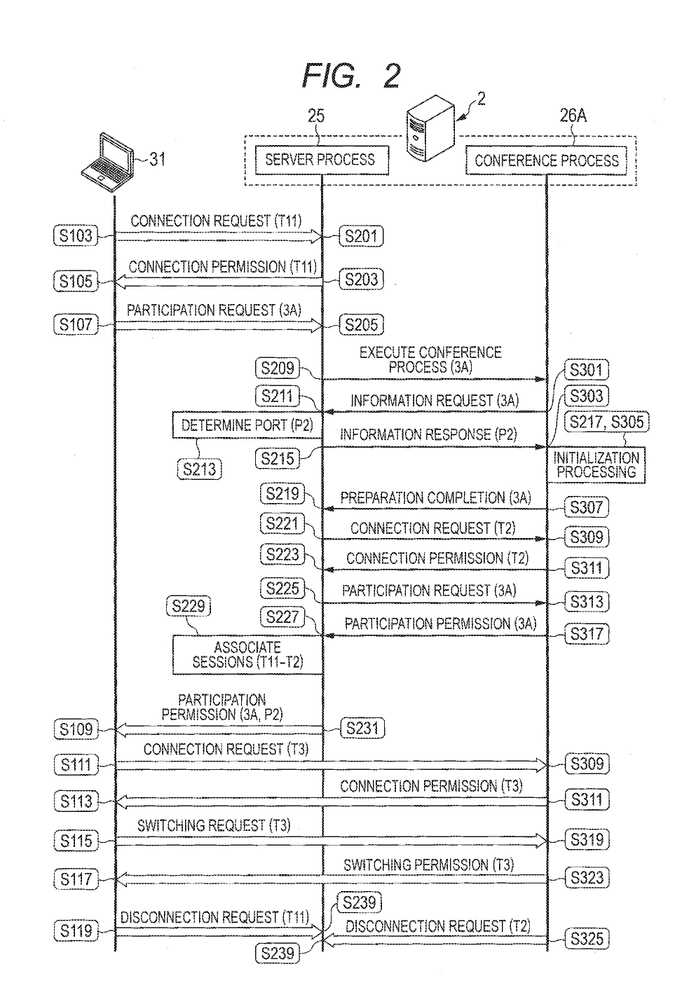

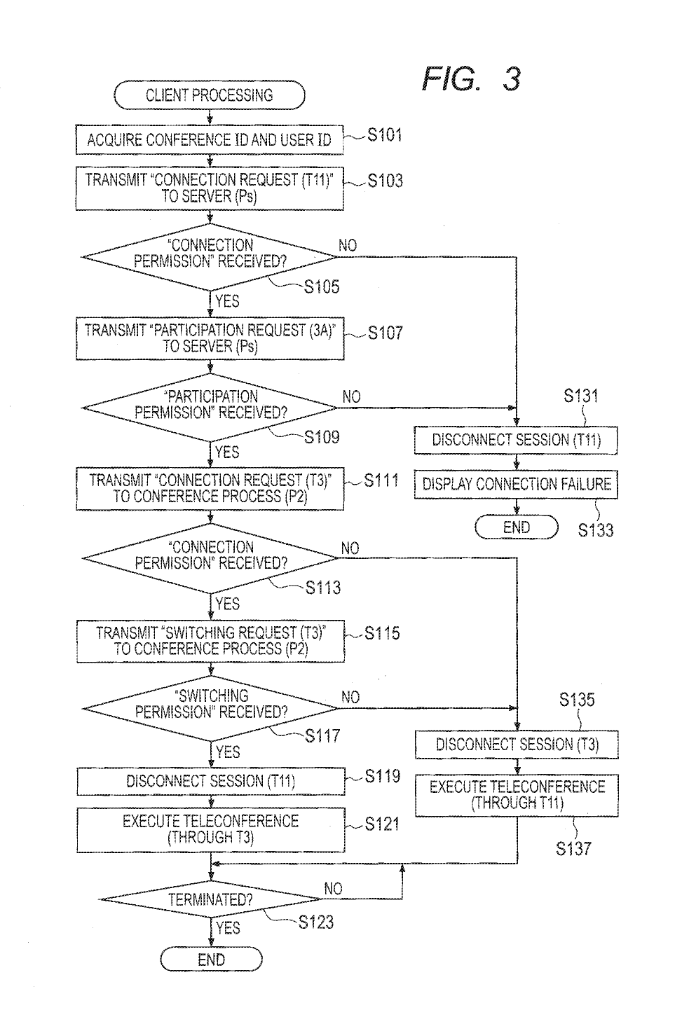

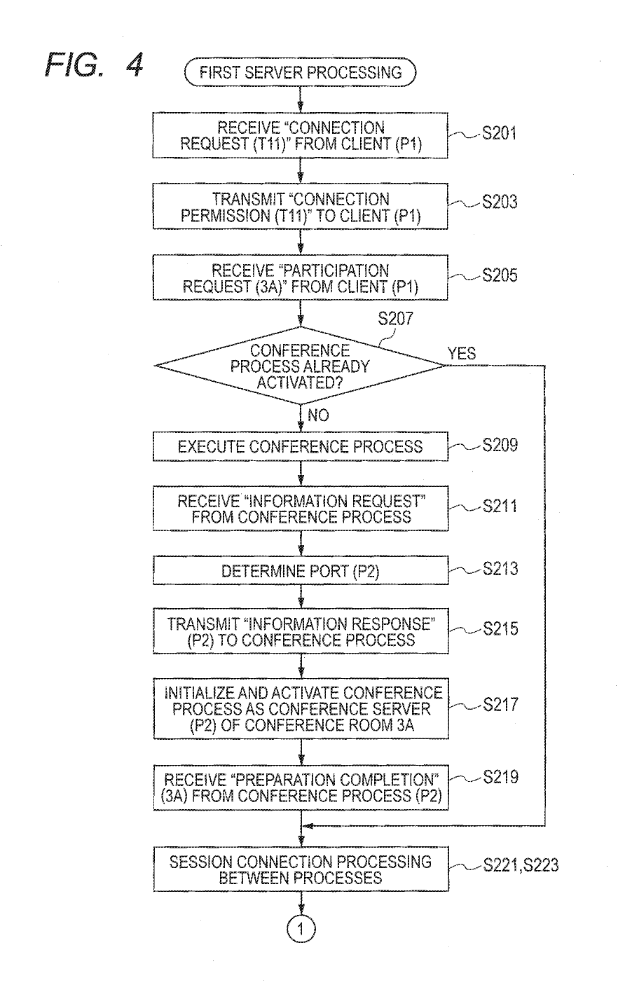

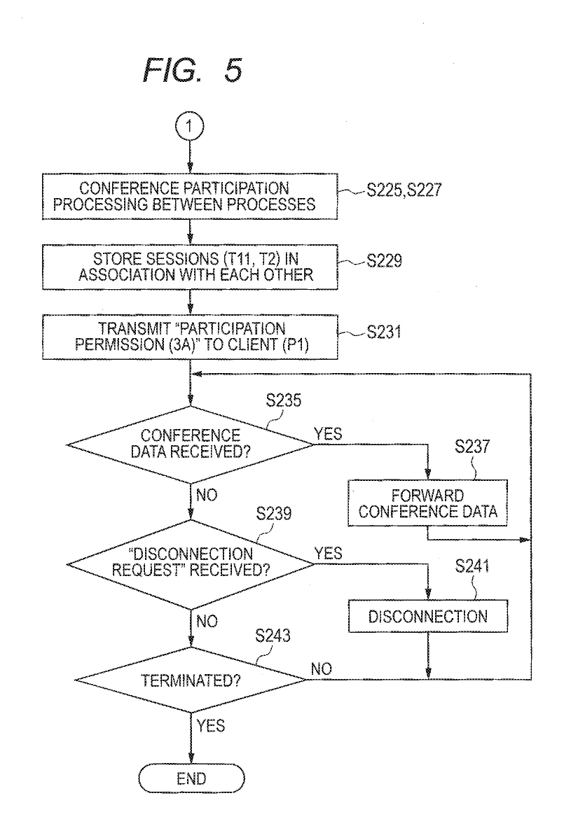

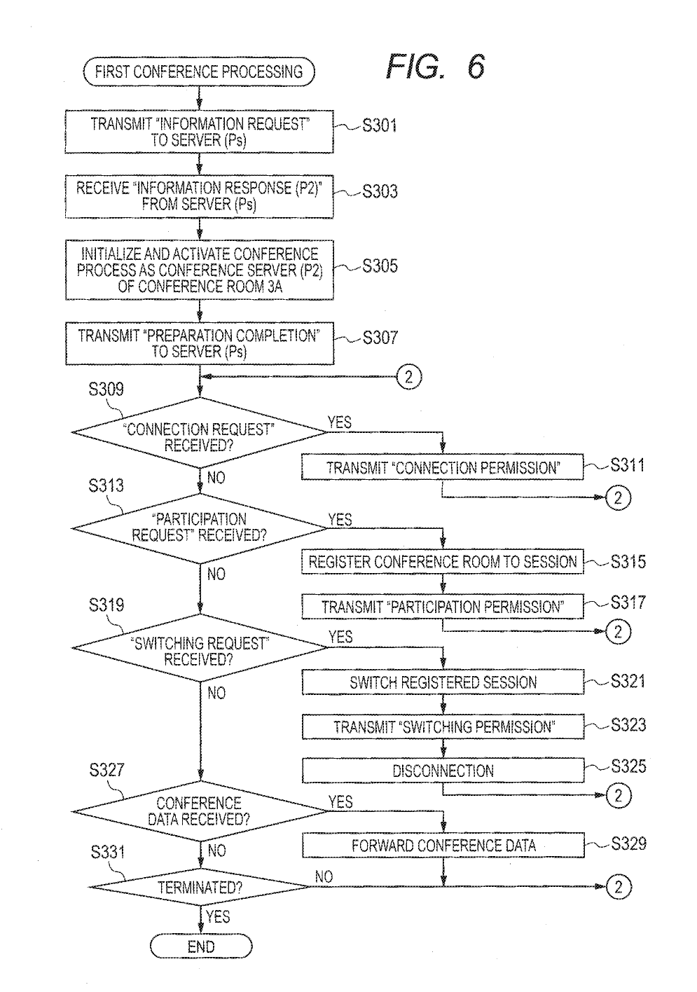

Referring to FIG. 2 to FIG. 6, a first communication sequence (see FIG. 2), and various flowcharts (client processing (see FIG. 3), first server processing (see FIG. 4 and FIG. 5), and first conference processing (see FIG. 6)) are described. When the first communication sequence and the flowcharts show the same step, the same step is indicated by the same reference numeral.

The client processing (see FIG. 3) is executed by the controller 36 of the clients 3. When an instruction for starting a teleconference is inputted through the input interface 38 (keyboard), the controller 36 executes the program stored in the memory 37, thereby starting the client processing. Hereinafter, a case where the clients 31A to 31D (hereinafter, collectively referred to as “client 31”) participate in the conference room 3A of the conference ID “3A” is described particularly as an example. The client 31 is preliminarily assigned with a port number “P1” for performing communication with the server 2. The session ID of the session connected between the client 31 and the server 2 is represented as “T11.”

The first sever processing (see FIG. 4 and FIG. 5) is executed by the server process 25 executed by the controller 21 of the server 2. When a session connection request (details will be described later) transmitted from the client 31 is received, the server process 25 executes the program stored in the memory 22, thereby starting the first server processing. Hereinafter, executing processing by the server process 25 executed by the controller 21 of the server 2 is referred to as “executing processing by the server process 25.” The server process 25 is preliminarily assigned with a standardly defined port number (well-known port) as a port number for performing communication with the clients 3 and the conference process 26. Hereinafter, this port number is referred to as “standard port” and represented as “Ps.”

The first conference processing (see FIG. 6) is executed by the conference process 26 executed by the controller 21 of the server 2. When the server process 25 executes the conference process 26, the conference process 26 executes the program stored in the memory 22, thereby starting the first conference processing. Hereinafter, executing processing by the conference process 26 executed by the controller 21 of the server 2 is referred to as “executing processing by the conference process 26.”

As shown in FIG. 3, a user of the client 31 inputs the conference ID “3A” and the user ID through the input interface 38 (keyboard) of the client 31 to request participation in the conference room 3A of the conference ID “3A”. The controller 36 of the client 31 acquires the conference ID “3A” and the user ID (S101). As shown in FIG. 2 and FIG. 3, the controller 36 transmits data for requesting connection of the session (referred to as “session connection request”) to a standard port “Ps” (S103). The session connection request includes a session ID “T11” of the session of which connection is requested. As shown in FIG. 2 and FIG. 4, the server process 25 receives the session connection request transmitted to the standard port “Ps” (S201). The server process 25 acquires the session ID “T11” included in the session connection request. The server process 25 transmits data for permitting connection of the session (referred to as “session connection permission”) to a port number “P1” that is the transmission source of the session connection request (S203). The session connection permission includes the session ID “T11” of the permitted session. By the processing in S201 and S203, the server process 25 connects the session of the session ID “T11” between the server process 25 and the client 31. Hereinafter, the session of the session ID “X” is referred to as “session X”.

As shown in FIG. 3, the controller 36 of the client 31 determines whether the session connection permission transmitted to the port number “P1” has been received (S105). When it is determined that the session connection permission has not been received (S105: NO), the controller 36 executes processing for disconnecting the session T11 (S131). The controller 36 outputs a screen for notifying that connection of the session T11 has failed, to the output interface 39 (LCD) (S133). The controller 36 terminates the client processing.

When it is determined that the session connection permission has been received (S105: YES), the controller 36 acquires the session ID “T11” included in the session connection permission. The controller 36 connects the session T11 with the server process 25. The controller 36 transmits data for requesting participation in the conference room (referred to as “conference participation request”) to the standard port “Ps” through the session T11 (S107). The conference participation request includes the conference ID “3A” of the conference room 3A for requesting participation. As shown in FIG. 2 and FIG. 4, the server process 25 receives the conference participation request transmitted to the standard port “Ps” through the session T11 (S205). The server process 25 acquires the conference ID “3A” included in the conference participation request.

As shown in FIG. 4, the server process 25 determines whether the conference process 26A has already been activated as the conference server for holding the conference room 3A (S207). When it is determined that the conference process 26A for holding the conference room 3A has already been activated (S207: YES), the server process 25 advances the processing to S221. In this case, although the details are described below, the server process 25 connects the session with the conference process 26A that has already been activated by using the port number assigned to the conference process 26A (S221, S223). On the other hand, when it is determined that the conference process 26A for holding the conference room 3A has not been activated (S207: NO), the server process 25 advances the processing to S209.

As shown in FIG. 2 and FIG. 4, the server process 25 executes the conference process 26A for holding the conference room 3A (S209). As shown in FIG. 2 and FIG. 6, the executed conference process 26A first transmits data for requesting acquisition of the port number that is necessary for holding the conference room (referred to as “conference information request”) to the standard port “Ps” (S301). The conference information request includes the conference ID “3A” of the conference room 3A held by the conference process 26A. As shown in FIG. 2 and FIG. 4, the server process 25 receives the conference information request transmitted to the standard port “Ps” (S211). The server process 25 acquires the conference ID “3A” included in the conference information request. The server process 25 determines a port number “P2” assigned to the conference process 26A that holds the conference room 3A (S213).

The server process 25 transmits data for notifying the determined port number (referred to as “conference information response”) to the conference process 26A (S215). The conference information response includes the determined port number “P2.” As shown in FIG. 2 and FIG. 6, the conference process 26A receives the conference information response (S303). The conference process 26A acquires the port number “P2” included in the conference information response.

As shown in FIG. 2, FIG. 4, and FIG. 6, the server process 25 and the conference process 26A use the port number “P2” to perform communication. The server process 25 initializes and activates the conference process 26A as the conference server holding the conference room 3A (S217, S305). As shown in FIG. 2 and FIG. 6, the conference process 26A transmits data for notifying that preparation for holding the conference room has been completed (referred to as “conference preparation completion”) to the standard port “Ps” (S307). The conference preparation completion includes the conference ID “3A” of the conference room 3A of which conference holding preparation has been completed. As shown in FIG. 2 and FIG. 4, the server process 25 receives the conference preparation completion transmitted to the standard port “Ps” (S219). The server process 25 acquires the conference ID “3A” included in the conference preparation completion.

The server process 25 transmits the session connection request for requesting connection of a session T2 to the port number “P2” (S221). The session connection request includes the session ID “T2” of the session T2 of which connection is requested. When it is determined that the conference process 26A has already been activated in the processing in S207 (S207: YES), the server process 25 transmits the session connection request to the port number “P2” assigned to the conference process 26A that has already been activated.

As shown in FIG. 6, the conference process 26A determines whether the session connection request transmitted to the port number “P2” has been received (S309). When it is determined that the session connection request has been received (S309: YES), the conference process 26A acquires the session ID “T2” included in the received session connection request. The conference process 26A transmits session connection permission that permits the connection of the session T2, to the standard port “Ps” (S311). The session connection permission includes the session ID “T2”. By the processing in S309 and S311, the conference process 26A uses the port number “P2” and connects the session T2 with the server process 25. The conference process 26 returns the processing to S309. When it is determined that the session connection request has not been received (S309: NO), the conference process 26A advances the processing to S313.

As shown in FIG. 2 and FIG. 4, the server process 25 receives the session connection permission transmitted from the conference process 26A to the standard port “Ps” (S223). The server process 25 acquires the session ID “T2” included in the session connection permission. By the processing in S221 and S223, the server process 25 uses the port number “P2” of the conference process 26A to connect the session T2 with the conference process 26.

As shown in FIG. 2 and FIG. 5, the server process 25 transmits the conference participation request received by the processing in S205 to the port number “P2” through the session T2 (S225). The conference participation request includes the conference ID “3A”. As shown in FIG. 6, the conference process 26A determines whether the conference participation request transmitted to the communication port “P2” has been received through the session T2 (S313). When it is determined that the conference participation request has been received (S313: YES), the conference process 26A acquires the conference ID “3A” included in the conference participation request. The conference process 26A associates the conference ID “3A” included in the conference participation request with the session ID “T2” of the session T2 connected with the server process 25 and stores the associated IDs in the memory 22 as registration information. Thereby, the conference room 3A is registered to the session T2 (S315).

As shown in FIG. 6, the conference process 26A transmits data for permitting participation in the conference room (referred to as “conference participation permission”) to the standard port “Ps” through the session T2 (S317). The conference participation permission includes the conference ID “3A” of the conference room 3A of which participation has been permitted. By the processing in S313, S315, and S317, the conference process 26A can perform communication of the conference data corresponding to the conference room 3A, with the server process 25 through the session T2. That is, the conference process 26A participates in the conference room 3A. The conference process 26A returns the processing to S309.

As shown in FIG. 2 and FIG. 5, the server process 25 receives the conference participation permission transmitted to the standard port “Ps” through the session T2 (S227). The server process 25 associates the session ID “T11” of the session T11 connected with the client 31 and the session ID “T2” of the session T2 connected with the conference process 26A, and stores the associated IDs in the memory 22 as associated information (S229). By the processing in the S225, S227, and S229, the server process 25 intermediates the conference data through the session T11 and the conference data through the session T2, and thereby performing communication of the conference data corresponding to the conference room 3A. That is, the server process 25 participates in the conference room 3A.

The server process 25 adds the port number “P2” determined by the processing in S213 to the received conference participation permission, and transmits the conference participation permission with the port number “P2” to the port number “P1” through the session T11 (S231).

As shown in FIG. 3, the controller 36 of the client 31 determines whether the conference participation permission to the port number “P1” has been received through the session T11 (S109). When it is determined that the conference participation permission has not been received (S109: NO), the controller 36 advances the processing to S131. The controller 36 executes processing for disconnecting the session T11 (S131) and then outputs a screen for notifying that connection of the session T11 has failed, to an output interface 34 (LCD) (S133). On the other hand, when it is determined that the conference participation permission has been received (S109: YES), the controller 36 acquires the port number (P2) included in the conference participation permission. By the processing in S107 and S109, the controller 36 can perform communication of the conference data corresponding to the conference room 3A with the server process 25 through the session T11. That is, the client 31 participates in the conference room 3A.

Until a session T3 (details will be described later) is connected with the conference process 26A after the conference participation permission has been received (S109: YES), the controller 36 participates in the conference room 3A through the session T11 and performs the teleconference.

The controller 36 transmits the conference data for all of the clients 31 who participate in the conference room 3A, to the standard port “Ps” through the session T11. As shown in FIG. 5, the server process 25 receives, through the session T11, the conference data transmitted from the client 31 to the standard port “Ps” (S235: YES). The server process 25 refers to the associated information stored in the memory 22 by the processing in S229 to identify the session ID “T2” associated with the session ID “T11.” The server process 25 forwards the received conference data to the port number “P2” through the session T2 (S237).

As shown in FIG. 6, the conference process 26A receives, through the session T2, the conference data transmitted to the port number “P2” (S313: NO, S319: NO, S327: YES). The conference process 26A refers to the registration information stored in the memory 22 by the processing in S315 to identify the conference ID “3A” associated with the session ID “T2.” The conference process 26A identifies the session ID associated with the conference ID “3A”. In a case where another client 31 participates in the conference room 3A, the session ID corresponding to the other client 31 is also associated with the conference ID “3A” and is stored as the registration information. The conference process 26A forwards the received conference data to the standard port “Ps” through the session of the identified session ID (S329).

As shown in FIG. 5, the server process 25 receives, through the session T2, the conference data transmitted to the standard port “Ps” (S235: YES). The server process 25 refers to the associated information stored in the memory 22 by the processing in S229 to identify the session ID associated with the session ID “T2.” In a case where another client 31 participates in the conference room 3A, the session ID corresponding to the other client 31 is also associated with the session ID “T2” and is stored as the associated information. The server process 25 forwards the received conference data through the ID session of the identified session ID (S237). The controller 36 of the client 31 who participates in the conference room 3A receives the conference data. By the processing described above, the client 31 who participates in the conference room 3A performs the teleconference by performing the communication of the conference data with the server process 25 through the session T11.

As shown in FIG. 2 and FIG. 3, after receiving the conference participation permission (S109: YES), the controller 36 transmits the session connection request for requesting the connection of the session T3 of the session ID “T3” to the communication port “P2” included in the conference participation permission received by the processing in S109 (S111). The session connection request includes the session ID “T3.”

As shown in FIG. 2 and FIG. 6, when it is determined that the session connection request transmitted to the port number “P2” has been received (S309: YES), the conference process 26A acquires the session ID “T3” included in the session connection request. The conference process 26A transmits the session connection permission to the port number “P1” that is the transmission source of the session connection request (S311). By the processing in S309 and S311, the conference process 26A uses the port number “P2” to connect the session T3 with the client 31.

As shown in FIG. 2 and FIG. 3, the controller 36 of the client 3 determines whether the session connection permission transmitted to the port number “P1” has been received (S113). When it is determined that the session connection permission has not been received (S113: NO), the controller 36 advances the processing to S135. The controller 36 executes processing for disconnecting the session T3 (S135). The controller 36 performs communication of the conference data with the server process 25 through the session T11 to participate in the conference room 3A and perform the teleconference (S137). The controller 36 advances the processing to S123.

When it is determined that the session connection permission has been received (S113: YES), the controller 36 uses the port number “P2” of the conference process 26A to connect the session T3 with the conference process 26A. As shown in FIG. 2 and FIG. 3, the controller 36 transmits data for requesting switching of the session (referred to as “session switching request”) for performing the conference room 3A in the conference process 26A, to the communication port “P2” through the session T3 (S115). The session switching request includes the conference ID “3A” and the session ID “T3” of the session after switching.

As shown in FIG. 6, when it is determined that the session switching request transmitted to the port number “P2” has been received (S319: YES), the conference process 26A advances the processing to S321. The conference process 26A acquires the conference ID “3A” and the session ID “T3” included in the session switching request. The conference process 26A refers to the registration information stored in the memory 22 by the processing in S315. The conference process 26A switches the session ID associated with the conference ID “3A” in the registration information from “T2” to “T3” (S321). The conference process 26A transmits data for permitting switching of the session (referred to as “session switching permission”) to the port number “P1” through the session T3 (S323). The session switching permission includes the switched session ID “T3.”

As shown in FIG. 3, the controller 36 of the client 31 determines whether the session switching permission transmitted to the port number “P1” has been received through the session T3 (S117). When it is determined that the session switching permission has not been received (S117: NO), the controller 36 advances the processing to S135. The controller 36 disconnects the session T3 (S135), and performs the communication with the server process 25 through the session T11 to participate in the conference room 3A and perform the teleconference (S137).

When it is determined that the session switching permission to the port number “P1” has been received through the session T3 (S117: YES), the controller 36 advances the processing to S119. The controller 36 transmits data for requesting disconnection of the session (referred to as “disconnection request”) to the standard port “Ps” through the session T11 (S119). The disconnection request incudes the session ID “T11” of the session T11 for requesting disconnection. As shown in FIG. 2 and FIG. 6, after the session switching request is transmitted by the processing in S323, the conference process 26A transmits the disconnection request to the standard port “Ps” through the session T2 (S325). The disconnection request includes the session ID “T2” of the session T2 of which disconnection is requested. As shown in FIG. 2 and FIG. 5, when the disconnection request to the standard port “Ps” has been received (S235: NO, S239: YES), the server process 25 acquires the session IDs “T11” and “T2” included in the disconnection request. The server process 25 disconnects the session T11 and T2 of the acquired session IDs (S241). By the processing in S119, S241, and S325, the session T11 between the client 31 and the server process 25 and the session T2 between the server process 25 and the conference process 26A are disconnected.

As shown in FIG. 3, after the session T11 with the server process 25 is disconnected, the controller 36 of the client 31 participates in the conference room 3A through the session T3 and performs the teleconference (S121). Details are as follows. The controller 36 transmits the conference data for the client 31 who participates in the conference room 3A to the port number “P2” through the session T3. As shown in FIG. 6, the conference process 26A receives, through the session T3, the conference data transmitted to the port number “P2” (S327: YES). The conference process 26A refers to the registration information stored in the memory 22 by the processing in S321, and identifies the conference ID “3A” associated with the session ID “T3”. The conference process 26A further identifies the session ID associated with the identified conference ID “3A”. The conference process 26A forwards the received conference data through the session of the identified session ID (S329). The controller 36 of the client 31 receives the conference data. By the processing described above, the client 31 who participates in the conference room 3A performs the teleconference by performing communication of the conference data with the conference process 26A through the session T3.

As shown in FIG. 3, until an instruction to terminate the teleconference is inputted through the input interface 38 such as a keyboard (S123: NO), the controller 36 of the client 3 participates in the conference room 3A to perform communication of the conference data and perform the teleconference. When it is determined that the instruction to terminate the teleconference is inputted through the input interface 38 (S123: YES), the controller 36 transmits data for terminating the teleconference (referred to as “termination instruction”) to the server process 25 and the conference process 26A. The controller 36 terminates the client processing. As shown in FIG. 5, the server process 25 continues forwarding processing of the conference data until the termination instruction is received (S243: NO). When it is determined that the termination instruction has been received (S243: YES), the server process 25 terminates the first server processing. As shown in FIG. 6, the conference process 26A participates in the conference room 3A to perform communication of the conference data and perform the teleconference until the termination instruction is received (S331: NO). When it is determined that the termination instruction has been received (S331: YES), the conference process 26A terminates the first conference processing.

<Overview of Second Communication Sequence>

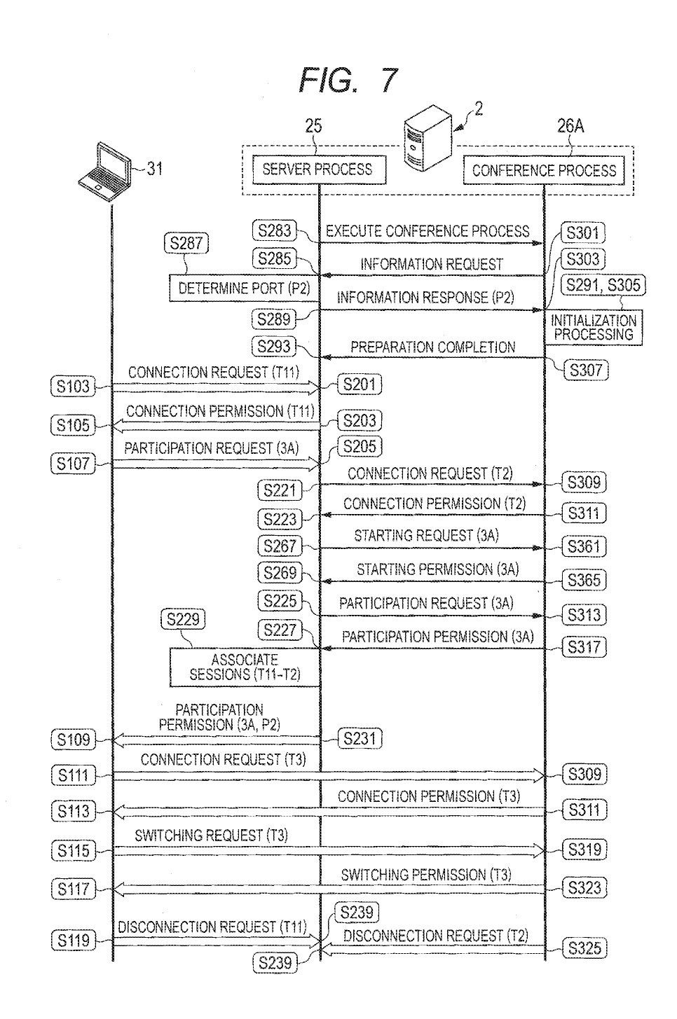

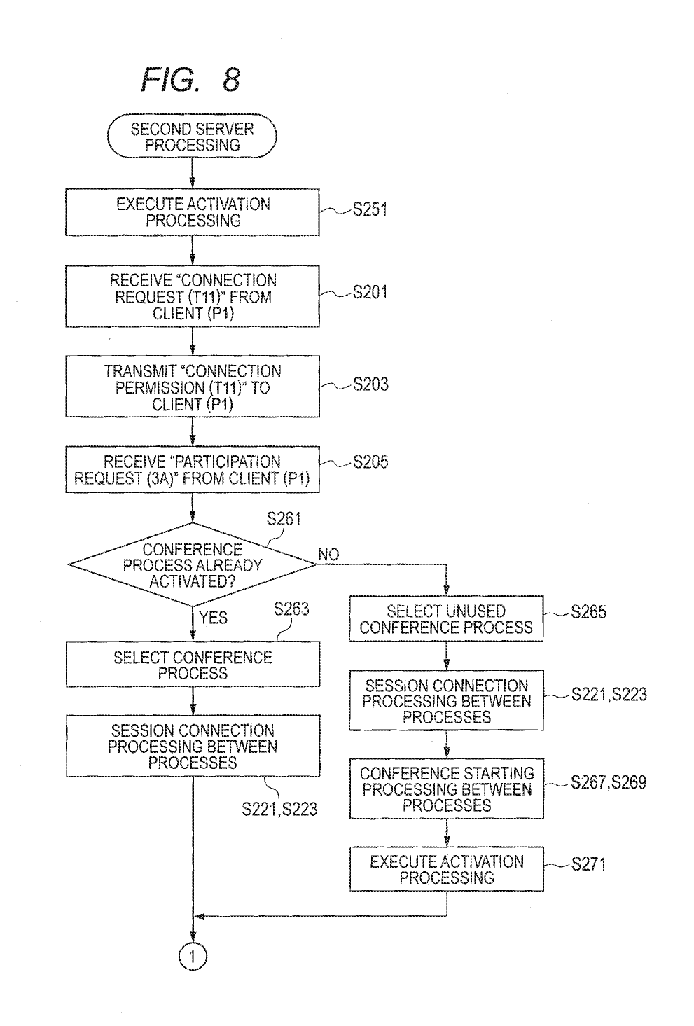

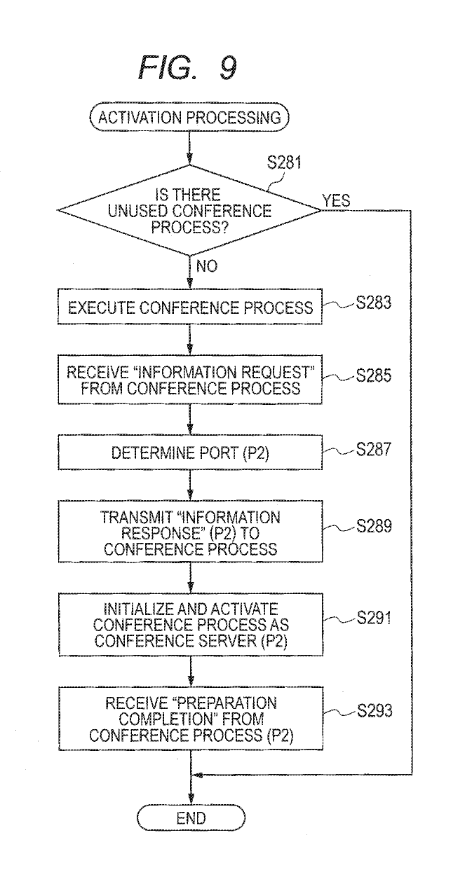

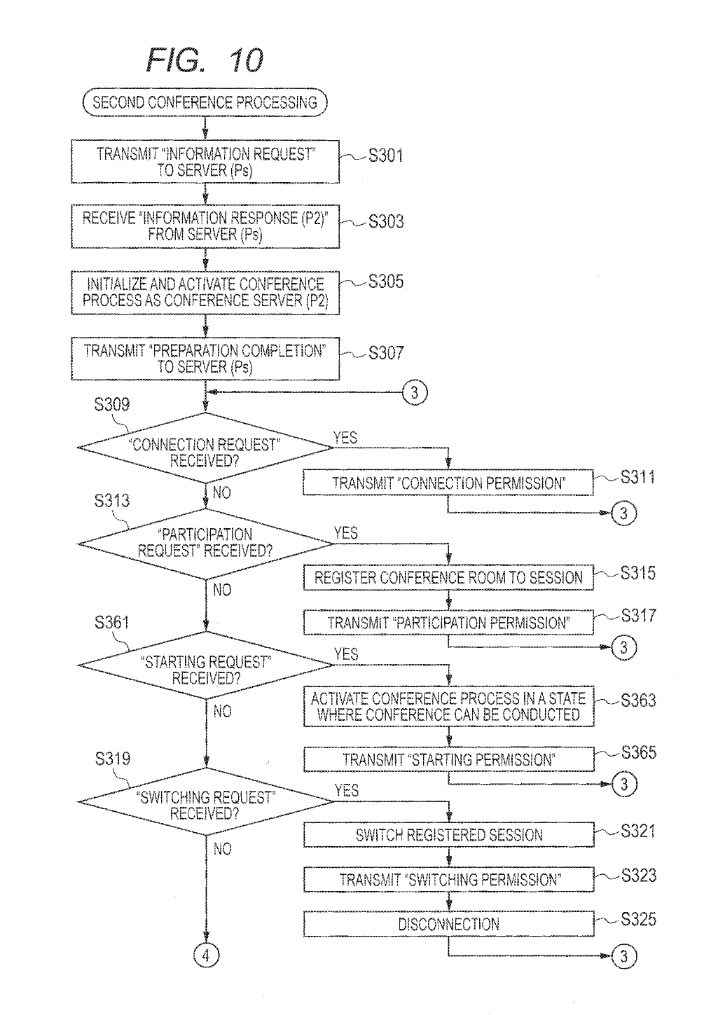

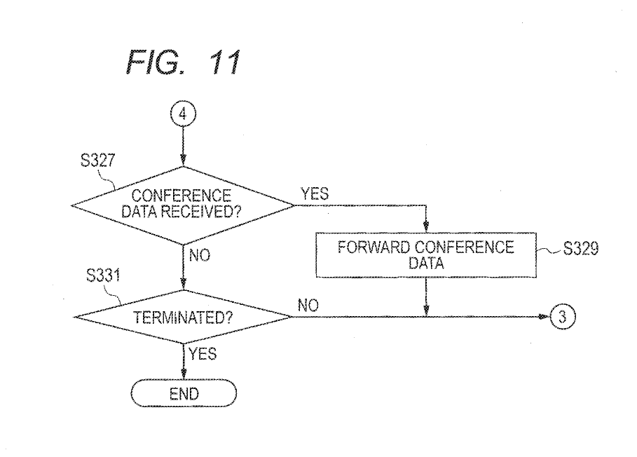

Referring to FIG. 7 and FIG. 11, a second communication sequence (see FIG. 7), and various flowcharts (second server processing (see FIG. 8), activation processing (see FIG. 9), and second conference processing (see FIG. 10 and FIG. 11)) are described. Since the client processing is the same as that of the first communication sequence (see FIG. 2), illustration and description thereof are omitted. When the same processing is described in the first communication sequence and the second communication sequence, and in the second communication sequence and the flowcharts, the same reference numerals are used. The second server processing and the activation processing are executed by the server process 25. The second conference processing is executed by the conference process 26.

The second communication sequence and the first communication sequence are different in that the conference process 26 is executed beforehand before the server process 25 receives the conference participation request from the client 3 (see S205). The conference process 26 is maintained to a state where a conference room to be held (that is, conference ID) is not determined (hereinafter, referred to as “unused state”). When the conference participation request is received from the client 3, the server process 25 selects the unused conference process 26 that has been executed beforehand and activates the conference process 26 as the conference process 26 that executes the conference room of a particular conference ID.

The second server processing is started by the execution, by the server process 25, of the program stored in the memory 22 when the power of the server 2 is inputted. As shown in FIG. 8, the server process 25 first executes the activation processing (see FIG. 9) (S251).

Referring to FIG. 9, the activation processing is described. The server process 25 determines whether there is an unused conference process 26 (S281). When it is determined that there is an unused conference process (S281: YES), the server process 25 terminates the activation processing. When it is determined that there is no unused conference processing 26 (S281: NO), the server process 25 advances the processing to S283.

As shown in FIG. 7 and FIG. 9, the server process 25 executes the conference process 26 (S283). Unlike the first communication sequence, the conference room to be held by the conference process 26 is not specified. As shown in FIG. 7 and FIG. 10, the executed conference process 26 transmits a conference information request for requesting acquisition of the port number, to the standard port “Ps” (S301). Unlike the first communication sequence, the conference information request does not include the conference ID “3A”. As shown in FIG. 7 and FIG. 9, the server process 25 receives the conference information request (S285). The server process 25 determines the port number “P2” assigned to the conference process 26 (S287). The server process 25 transmits conference information response to the conference process 26 (S289). The conference information response includes the determined port number “P2.” As shown in FIG. 7 and FIG. 10, the conference process 26 receives the conference information response (S303). The conference process 26 acquires the port number “P2” included in the conference information response.

As shown in FIG. 7, FIG. 9 and FIG. 10, the server process 25 initiates and activates the conference process 26 as a conference server performing communication and holding the conference room by using the port number “P2” (S291, S305). As shown in FIG. 7 and FIG. 10, the conference process 26 transmits conference preparation completion to the standard port “Ps” (S307). Unlike the first communication sequence, the conference preparation completion does not include the conference ID. As shown in FIG. 7 and FIG. 9, the server process 25 receives the conference preparation completion (S293). The server process 25 terminates the activation processing.

As shown in FIG. 7, the controller 36 of the client 31 transmits the session connection request for requesting the connection of the session T11 to the standard port “Ps” (S103). As shown in FIG. 7 and FIG. 8, the server process 25 receives the session connection request (S201). The server process 25 transmits the session connection permission to the port number “P1” (S203). Thereby, the server process 25 connects the session T11 with the client 31.

After receiving the session connection permission (S105), the controller 36 transmits the conference participation request for requesting participation in the conference room of the conference ID “3A” through the session T11 (S107). As shown in FIG. 7 and FIG. 8, the server process 25 receives the conference participation request through the session T11 (S205). The server process 25 determines whether the conference process 26 has already been activated as the conference server holding the conference room 3A (S261). When it is determined that the conference process 26 has not been activated (S261: NO), the server process 25 advances the processing to S265.

As shown in FIG. 8, the server process 25 selects the unused conference process 26 from the conference processes 26 executed by the activation processing (see FIG. 9) (S265). The server process 25 acquires the port number “P2” assigned to the selected conference process 26. The server process 25 transmits the session connection request for requesting the connection of the session T2, to the port number “P2” (S221). As shown in FIG. 10, when it is determined that the session connection request has been received (S309: YES), the conference process 26 transmits the session connection permission to the standard port “Ps” (S311). The conference process 26 uses the port number “P2” to connect the session T2 with the server process 25. As shown in FIG. 7 and FIG. 8, the server process 25 receives the session connection permission transmitted to the standard port “Ps” from the conference process 26 (S223). The server process 25 uses the port number “P2” of the conference process 26 to connect the session T2 with the conference process 26.

The server process 25 transmits data for requesting start of the conference room (referred to as “conference starting request”) through the session T2 (S267). The conference starting request includes the conference ID “3A” of the conference room 3A that is requested. As shown in FIG. 10, the conference process 26 determines whether the conference starting request has been received through the session T2 (S309: NO, S313: NO, S361). When it is determined that the conference starting request has been received (S361: YES), the conference process 26 advances the processing to S363. The conference process 26 acquires the conference ID “3A” included in the received conference starting request. The conference process 26 is activated as the conference server holding the conference room 3A (S363). Hereinafter, the conference process 26 that has been activated as the conference server holding the conference room 3A is referred to as “conference process 26A”.

The conference process 26A transmits data for permitting starting conference (referred to as “conference starting permission”) to the standard port “Ps” through the session T2 (S365). The conference process 26A returns the processing to S309. As shown in FIG. 7 and FIG. 8, the server process 25 receives the conference starting permission through the session T2 (S269). The server process 25 executes the activation processing (see FIG. 9) in order to secure the unused conference process 26 (S271). The server process 25 advances the processing to S225 (see FIG. 5). The processing in S225 to S243 is the same as that in the first server processing (see FIG. 5) and therefore description thereof is omitted.

As shown in FIG. 8, when it is determined that the conference process 26A has already been activated as the conference server holding the conference room 3A (S261: YES), the server process 25 advances the processing to S263. The server process 25 selects the conference process 26A that has already been activated (S263). The server process 25 acquires the port number “P2” assigned to the selected conference process 26A. The server process 25 transmits the session connection request for requesting connection of the session T2 to the port number “P2” (S221). The server process 25 receives the session connection permission transmitted from the conference process 26A in response to the session connection request (S223). Thereby, the server process 25 uses the port number “P2” of the conference process 26A to connect the session T2 with the conference process 26A. The server process 25 advances the processing to S225 (see FIG. 5). Processing in S225 to S243 is the same as that in the first server processing (see FIG. 5), and therefore description thereof is omitted. The conference process 26A uses the port number “P2” to connect the session T2 with the server process 25. The processing in S319 to S325 in FIG. 10 and S327 to S331 in FIG. 11 is the same as that in the first conference processing (see FIG. 6), and therefore description thereof is omitted.

The server process 25 activates the conference process 26 for each conference room having a different conference ID. The activated conference process 26 connects the session with the client 3 and performs communication of the conference data in order to perform the teleconference. For example, even when a failure occurs in the conference process 26 corresponding to a particular teleconference, the failure does not tend to affect the other conference process 26. Therefore, the other conference process 26 can stably continue the teleconference by continuously holding the other conference room even after the failure occurs in the conference process 26 corresponding to the particular teleconference. The conference process 26 is activated by the server process 25. Accordingly, the server 2 can easily realize the teleconference system in which a plurality of conference rooms are stably held.

The client 31 directly connects the session T3 with the conference process 26A and can perform communication for the teleconference through the session T3. At this time, the server process 25 does not intervene in the communication between the client 3 and the conference process 26A. That is, each of the conference processes 26 can almost evenly process communication for the corresponding teleconference. Accordingly, a processing load can be prevented from concentrating in the server process 25 when a plurality of teleconferences is held in the same period. The overall processing of the plurality of teleconferences can be prevented from being slow caused by the server process 25 being a bottleneck.

In the first communication sequence, when receiving the conference participation request for participating in the conference room 3A from the client 3 (S205), the server process 25 determines whether the conference process 26A has already been activated as the conference server for holding the conference room 3A. When it is determined that the conference process 26A for holding the conference room 3A has already been activated (S207: YES), the server process 25 uses the port number “P2” assigned to the conference process 26A to connect the session with the conference process 26A that has already been activated (S221, S223). That is, when there is a client 3 who participates in the conference room 3A being held, in the middle, the server process 25 uses the port number “P2” of the conference process 26A that has already been activated to connect the session (T2) with the conference process 26A. In this case, the server process 25 can prevent a load of the controller 21 from increasing due to increase in the number of the conference processes 26 to be executed.

In the first communication sequence and the second communication sequence, first, the session (T1) between the server process 25 and the client 3 is connected, then the session T2 between the server process 25 and the conference process 26A is connected, and lastly, the session T3 between the client 3 and the conference process 26A is connected. The client 3 uses the standard port “Ps” of the server process 25 and perform communication with the server process 25 through the session (T1) to perform the teleconference, until the session T3 with the conference process 26A is connected. In this case, even when the connection of the session T3 between the client 3 and the conference process 26A is impossible due to the effect of a security function such as a firewall, in a communication system 1, the client 3 can perform communication with the conference process 26A through the server process 25 to perform the teleconferences. When the connection of the session T3 between the client 3 and the conference process 26A is successful, the session (T1) between the server process 25 and the client 3 and the session T2 between the server process 25 and the conference process 26A are disconnected. Thereafter, communication between the client 3 and the conference process 26A is directly performed through the session T3. In this case, the server process 25 does not intervene in communication, and therefore, a communication load can be prevented from concentrating in the server process 25.

When a processing load of the controller 21 of the server 2 is large, activating of the conference process 26 may require much time. To deal with this, in the second communication sequence, the server process 25 executes and activates the conference process 26 before receiving the conference participation request for participating in the conference room 3A from the client 3 (S251). When receiving the conference participation request from the client 3, the server process 25 selects an unused conference process 26 out of the conference processes 26 that have already been executed (S265) and makes the conference process 26 hold the conference room 3A and perform the teleconference. Thereby, the server process 25 can shorten time from reception of the conference participation request from the client 3 until the participation in the teleconference is enabled.

While the disclosure has been described in detail with reference to the above aspects thereof, it would be apparent to those skilled in the art that various changes and modifications may be made therein without departing from the scope of the claims.

The connection method of the session T11 between the server process 25 and the client 31 is not limited to the method described above. For example, the session connection request may be transmitted from the server process 25 to the client 31 and the session connection permission is transmitted from the client 31 to the server process 25, and thereby, the session T11 is connected.

The server process 25 may randomly determine the port number of the conference process 26. Alternatively, the server process 25 may determine the port number of the conference process 26 by selecting a port number from the candidate list of the port numbers preliminarily stored in the memory 22. The candidate list may preliminarily include the port number by which the session T3 between the client 31 and the conference process 26 can be connected, that is, the port number by which the client 31 can perform communication with the conference process 26.

When receiving the conference participation request of the conference room 3A from the client 31, the server process 25 may newly activate the conference process 26A regardless of whether the conference process 26 has already been activated as the conference server for holding the conference room 3A. That is, a plurality of conference processes 26 holding the same conference room 3A may be activated. In this case, for example, the teleconference may be performed by communication among the plurality of conference processes 26 holding the same conference room 3A.

In the first communication sequence and the second communication sequence, the method of disconnecting the session T11 and T2 after the session T3 between the client 31 and the conference process 26A is connected, is not limited to the method described above. For example, the client 31 and the conference process 26A may transmit connection completion notification of the session T3 to the server process 25. When receiving the connection completion notification, the server process 25 may disconnect the session T11 and T2. Further, even after the session T3 is connected, the session T11 and T2 may be maintained. The client 31 and the conference process 26 may switch between using the session 11 and T2 to perform the teleconference through the server process 25 and using the session T3 to directly perform the teleconference, depending on the communication state of the network.

In the second communication sequence, the number of the conference processes 26 executed beforehand before the server process 25 receives the conference participation request is not limited to one and may be two or more. The activation processing may be started when the number of the unused conference processes 26 becomes a particular number or less to activate the conference process 26.

The server process 25 may not be always executed. For example, the server process 25 may be started when the session connection request is received from the client 31, and may perform the first server processing or the second server processing. The server process 25 may end after the session T3 between the client 31 and the conference process 26 is connected and the sessions T11 and T2 are disconnected.

What is claimed is:

1. A communication method for performing a teleconference between clients through a server, the communication method comprising:
connecting the server with a client;
receiving, by the server, a participation request transmitted from the client, the participation request including a conference ID of the teleconference;
executing, by the server, a conference process for performing the teleconference;
determining, by the server, a port number corresponding to the conference ID;
transmitting the port number from the server to the conference process;
in response to reception of the port number by the conference process, activating, by the server, the conference process as a conference server that performs the teleconference by using the port number;
connecting the server with the conference process by using the port number;
transmitting the participation request from the server to the conference process;
in response to reception of the participation request by the conference process and to transmission of a participation permission to the server by the conference process, receiving the participation permission by the server;
transmitting the participation permission from the server to the client, the participation permission including the port number;
in response to reception of the participation permission by the client, connecting the client with the conference process by using the port number included in the participation permission; and
performing communication for performing the teleconference corresponding to the conference ID between the client and the conference process.

2. The communication method according to claim 1, wherein the server activates a conference process for each conference room having a different conference ID.

3. The communication method according to claim 1, wherein the client performs communication for performing the teleconference through a session directly connected between the client and the conference process without the server intervening in the communication between the client and the conference process.

4. The communication method according to claim 3, further comprising:
when the session between the client and the conference process is connected successfully, disconnecting a session between the server and the client and a session between the server and the conference process.

5. The communication method according to claim 1, further comprising:
after connecting a session between the client and the conference process is connected successfully, maintaining a session between the server and the client and a session between the server and the conference process; and
switching, depending on a communication state of a network, between:
using the session between the server and the client and the session between the server and the conference process to perform the teleconference through the server; and
using the session between the client and the conference process to directly perform the teleconference.

6. A non-transitory computer-readable storage medium storing a communication program, the communication program being executable on a computer of a server, the communication program causing, when executed, the server to perform operations comprising:
connecting with a client;
receiving a participation request transmitted from the client, the participation request including a conference ID of a teleconference;
executing a conference process for performing the teleconference;
determining a port number corresponding to the conference ID;
transmitting the port number to the conference process;
activating the conference process as a conference server that performs the teleconference by using the port number;
connecting with the conference process by using the port number;
transmitting the participation request to the conference process;
receiving a participation permission transmitted from the conference process in response to transmission of the participation request; and
transmitting the participation permission to the client, the participation permission including the port number.

7. The non-transitory computer-readable storage medium according to claim 6, wherein the communication program further causes, when executed, the server to perform operations comprising:
determining whether the conference process is already activated as a conference server corresponding to the conference ID included in the participation request; and
in response to determining that the conference process is already activated, connecting with the already activated conference process by using the port number that is used when the already activated conference process performs the teleconference.

8. The non-transitory computer-readable storage medium according to claim 7, wherein the communication program further causes, when executed, the server to perform operations comprising:
in response to determining that there is no conference process that is already activated as the conference server corresponding to the conference ID included in the participation request, executing the conference process for performing the teleconference of the conference ID.

9. The non-transitory computer-readable storage medium according to claim 6, wherein the communication program further causes, when executed, the server to perform operations comprising:
after connecting with the conference process and before the client and the conference process connect with each other, intermediating communication for performing the teleconference between the client and the conference process; and
after the client and the conference process connect with each other, terminating connection with the client and connection with the conference process.

10. A non-transitory computer-readable storage medium storing a communication program, the communication program being executable on a computer of a server, the communication program causing, when executed, the server to perform operations comprising:
executing a conference process for performing a teleconference;
determining a port number in response to a port request transmitted from the executed conference process;
transmitting the port number to the conference process;
activating the conference process as a conference server that performs the teleconference by using the port number;
connecting with a client;
receiving a participation request transmitted from the client, the participation request including a conference ID of the teleconference;
selecting an unused conference process from the activated conference process;
connecting with the selected conference process by using the port number;
transmitting the participation request to the conference process;
receiving a participation permission transmitted from the conference process in response to transmission of the participation request; and
transmitting the participation permission to the client, the participation permission including the port number.

11. The non-transitory computer-readable storage medium according to claim 10, wherein the communication program further causes, when executed, the server to perform operations comprising:
determining whether there is a conference process corresponding to the teleconference of the conference ID included in the participation request; and
in response to determining that there is a conference process corresponding to the teleconference of the conference ID, selecting the conference process corresponding to the teleconference of the conference ID.

12. The non-transitory computer-readable storage medium according to claim 10, wherein the communication program further causes, when executed, the server to perform operations comprising:
after selecting the unused conference process, activating another conference process to secure an unused conference process.

13. The non-transitory computer-readable storage medium according to claim 12, wherein the communication program further causes, when executed, the server to perform operations comprising:
when a number of unused conference processes becomes a particular number or less, activating another conference process to secure an unused conference process.

14. The non-transitory computer-readable storage medium according to claim 10, wherein the unused conference process is a conference process for which a conference ID is not determined.
